(19) United States
(12) Patent Application Publication
(10) Pub. No.: US 2022/0364191 A1
(43) Pub. Date: Nov. 17, 2022

(54) METHOD FOR PRODUCING A PRESS-HARDENED SHEET STEEL PART HAVING AN ALUMINIUM-BASED COATING, INITIAL SHEET METAL BLANK, AND A PRESS-HARDENED SHEET STEEL PART MADE THEREFROM

(71) Applicant: Salzgitter Flachstahl GmbH, Salzgitter (DE)

(72) Inventors: Friedrich Luther, Gehrden (DE); Marc Debeaux, Hildesheim (DE); Frank Beier, Staufenberg (DE); Kerstin Körner, Braunschweig (DE)

(21) Appl. No.: 17/763,449

(22) PCT Filed: Sep. 28, 2020
(86) PCT No.: PCT/EP2020/077133

§ 371 Date: Mar. 24, 2022

(30) Foreign Application Priority Data
Sep. 30, 2019 (DE) 10 2019 126 378.6

(51) Int. Cl. C21D 1/673; C21D 8/02; C23C 2/12; C23C 2/40; C23C 28/02; B21D 35/00; C21D 9/46

(52) U.S. Cl. CPC C21D 1/673; C21D 8/0236; C23C 2/12; C23C 2/40; C23C 28/021; B21D 35/007; C21D 9/46; C21D 2211/008

(57) ABSTRACT

A method for producing a press-mold-hardened part includes providing a steel strip having an aluminium-based coating; applying an inorganic, iron-containing conversion layer to the aluminium-based coating with a layer weight in relation to iron of 3-30 mg/m2; cold-rolling the steel strip to form a flexibly rolled strip with strip sections of different sheet thickness; cutting an initial sheet metal blank out of the flexibly rolled strip, with the blank having different sheet thicknesses with thinnest and thickest sheet sections; press-mold-hardening the initial sheet metal blank to form a part. Alternatively, the cold-rolling can take place before the cutting, and the application of the conversion layer can take place before or after the cutting, or, instead of the cold-rolling, at least two steel strip sections having an aluminium-based coating and different sheet thicknesses can be welded together, where the application of the conversion layer can take place before or after welding.

### CROSS REFERENCE TO RELATED APPLICATION

The present application claims the priority benefits of International Patent Application No. PCT/EP2020/077133, filed Sep. 28, 2020, and claims benefit of German patent application no. 10 2019 126 378.6, filed on Sep. 30, 2019.

### BACKGROUND AND FIELD OF THE INVENTION

The invention relates to a method for producing a press-hardened sheet steel component with very good lacquering capability and weldability in all regions of this component, which has been produced from a starting blank with different sheet thicknesses and in which the starting blank has a hot-dip coat based on aluminum. Furthermore, the invention relates to a starting blank with different sheet thicknesses and an aluminum-based coat, as well as to a press-hardened component consisting of such a starting blank. Different sheet thicknesses for the starting blank are understood hereinafter to be a sheet thickness difference in which the sheet thickness of a thin part of the starting blank has only 80% of the sheet thickness of the blank part with a greatest sheet thickness or less.

Aluminum-based coats are understood hereinafter to be metallic coats, in which aluminum is the main constituent in mass percent. Examples of possible aluminum-based coats are aluminum, aluminum-silicon (AS), aluminum-zinc-silicon (AZ), and the same coats with admixtures of additional elements, such as e.g. magnesium, manganese, titanium and rare earths. Typical layer requirements for this coat are about 60 g/m² to about 200 g/m² on both sides.

It is known that hot-formed steel sheets are being used with increasing frequency in particular in automotive engineering. By means of the process which is defined as press-hardening, it is possible to produce high-strength components which are used predominantly in the region of the bodywork. Press-hardening can fundamentally be carried out by means of two different method variations, namely by means of the direct or indirect method. Whereas the process steps of forming and hardening are performed separately from one another in the indirect methods, they take place together in one tool in the direct method. However, only the direct method will be considered hereinafter.

In the direct method, a steel sheet blank is heated above the so-called austenitization temperature (Ac3), the thus heated blank is then transferred to a forming tool and formed in a single-stage formation step to make the finished component and in this case is cooled by the cooled forming tool simultaneously at a rate above the critical cooling rate of the steel so that a hardened component is produced.

Known hot-formable steels for this area of application are e.g. the manganese-boron steel “22MnB5” and latterly also air-hardenable steels according to European patent EP 2 449 138 B1.

In addition to uncoated steel sheets, steel sheets comprising scaling protection for press-hardening are also used in the automotive industry. The advantages here are that, in addition to the increased corrosion resistance of the finished component, the blanks or components do not become scaled in the furnace, whereby wearing of the pressing tools by flaked-off scales is reduced and the components do not have to undergo costly blasting prior to further processing.

The production of components by means of quenching of pre-products which are coated with an aluminum alloy and consist of press-hardenable steels by hot-forming in a forming tool is known from German patent DE 699 33 751 T2. In this case, a sheet which is coated with an aluminum alloy is heated to above 700° C. prior to forming, wherein an intermetallic alloyed compound on the basis of iron, aluminum and silicon is produced on the surface and subsequently the sheet is formed and cools at a rate above the critical cooling rate.

From laid-open document DE 10 2015 122 410 A1, e.g. methods are known for the production of crash-relevant bodywork components, in which starting blanks with an aluminum-based coat are used which are individually tailored to the component requirements. For example, forming blanks are used which have different material thicknesses and/or qualities. So-called flexibly rolled sheets have different material thicknesses with the same material quality tailored to requirement. With welded blanks (TWB=Tailored Welded Blanks), not only the material thickness but also the material quality can be changed. Components for which such methods are considered can be found e.g. for the automotive industry in the entire bodywork-in-white of vehicles, such as e.g. in A-pillars, B-pillars, side members, cross members, bumpers, side impact beams, wheel arches and the like.

A problem in the use of aluminum-based coats, e.g. consisting of aluminum-silicon (AS), is the insufficient lacquering-suitability of the formed component in cathodic dip coating (CDC), typical for automobiles, when too short a heating time has been used for press-hardening. In the case of short heating times, the CD-coated substrate then has insufficient lacquer-bonding.

Therefore, the aluminum-based coat must thoroughly alloy sufficiently with iron from the steel substrate during heating before press-hardening in order to ensure effective lacquer-bonding, e.g. in a cathodic dip coating process. In the course of heating, a diffusion zone of Fe(Al,Si) is formed on the steel substrate, which is followed by a zone with various intermetallic phases. Moreover, by reason of the oxidation in the furnace as well as during the transfer into the press, only a very thin aluminum oxide layer is formed on the surface. A corresponding layer structure is illustrated in FIG. 1.

However, the aluminum-based coating also must not be thoroughly alloyed excessively, as otherwise problems can occur during joining, especially during spot welding. The thickness of the so-called diffusion layer between steel and coat is often used as a limit for spot welding suitability. In the VW Group Standard TL 4225, this limit is e.g. a maximum of 16 μm.

In the case of starting blanks having different sheet thicknesses, sufficient thorough alloying of the Al-based coat must therefore also be achieved in the region of the greater sheet thickness on the one hand in order to achieve effective lacquer-bonding, and on the other hand the thorough alloying also must not be excessive in the thinner region of the blank in order not to negatively influence the weldability. Typical sheet thicknesses for a steel strip used as a starting material are between 0.50 to 3.00 mm, preferably between 0.75 and 2.50 mm.

However, it has been shown that starting blanks having different sheet thicknesses heat up differently during heating before press hardening. The region of the starting blank having a small sheet thickness heats up significantly faster than the region having a large sheet thickness. The metallographic specimen therefore often has only a very thin diffusion layer in the region of the component having a greater sheet thickness, but in the region of the component having the smaller sheet thickness said specimen has a diffusion layer thickness close to the permissible upper limit of 16 μm. This can result in press-hardened components with inhomogeneous properties.

Therefore, starting blanks having different sheet thicknesses which have an aluminum-based coat have only a limited process window for heating, e.g. in a roller hearth furnace during press-hardening. The thicker blank part determines the minimum heating time in the furnace to ensure sufficient lacquer-bonding, and the thin blank part limits the maximum dwell time in the furnace to ensure good weldability. In particular, in the case of large differences in thickness, e.g. in blanks having sheet thicknesses of 2.0 mm in the thickest region and 1.0 mm in the thinnest region, the resulting process window can thus be smaller.

### SUMMARY OF THE INVENTION

The present invention provides a method for producing a press-hardened sheet steel component from a starting blank having different sheet thicknesses and an aluminum-based coat, with which a comparably large process window is achieved during heating compared to starting blanks having a constant sheet thickness and in which homogeneous properties with regard to lacquering capability and weldability are present on the press-hardened component. The invention also provides a starting blank and a press-form-hardened component produced therefrom.

The teaching of the invention includes a method for producing a press-hardened component from a starting blank having different sheet thicknesses, where the starting blank has an aluminum-based coat, comprising the steps of: providing a steel strip having an aluminum-based coat; applying an inorganic iron-containing conversion layer on the aluminum-based coat having a layer weight related to iron of 3-30 mg/m²; cold-rolling the steel strip into a flexibly rolled strip having strip portions of different sheet thickness; cutting a starting blank from the flexibly rolled strip, wherein the starting blank has different sheet thicknesses with a thinnest and a thickest sheet portion; press-form-hardening the starting blank to form a component.

The teaching of the invention likewise includes a method for producing a press-form-hardened component from a starting blank having different sheet thicknesses, wherein the starting blank has an aluminum-based coat, comprising the steps of: providing a steel strip having an aluminum-based coat; cold-rolling the steel strip into a flexibly rolled strip having strip portions of different sheet thickness; cutting a starting blank from the flexibly rolled strip, wherein the starting blank has different sheet thicknesses with a thinnest and a thickest sheet portion; before or after cutting the starting blank, applying an inorganic iron-containing conversion layer locally or to the entire surface of the aluminum-based coat having a layer weight related to iron of 3-30 mg/m² at least in the region of the thickest sheet portion; press-form-hardening the starting blank to form a component.

A further alternative teaching of the invention includes a method for producing a press-form-hardened component from a starting blank having different sheet thicknesses, where the starting blank has an aluminum-based coat, comprising the steps of: providing at least two steel strip portions having an aluminum-based coat which have different sheet thicknesses; welding the steel strip portions together to form a starting blank, wherein the starting blank has different sheet thicknesses with a thinnest and a thickest sheet portion; before or after welding said steel strip portions together, applying an inorganic iron-containing conversion layer locally or to the entire surface of the aluminum-based coat having a layer weight related to iron of 3-30 mg/m² at least in the region of the thickest sheet portion; press-form-hardening the starting blank to form a component.

In the case of these methods in accordance with the invention, a comparably large process window in comparison with a uniform thickness of the starting blank is very advantageously achieved during heating in the course of press-form-hardening, and comparably homogeneous properties with regard to lacquering capability and weldability are likewise achieved on the press-hardened component.

Fundamentally, it is also possible to start the methods in accordance with the invention by applying the aluminum-based coating after flexible rolling, instead of starting with a steel strip already provided with an aluminum-based coat.

For economic reasons and in terms of a sufficient weight saving of the press-hardened component, the sheet thickness of the thinnest sheet portion of the starting blank should be at most 80%, preferably 70% or less, of the thickness of the thickest sheet portion of the starting blank.

The core of the invention thus resides in the application of an inorganic iron-containing conversion layer which has been applied as a pre-coating to the aluminum-based coat of the starting blank or the steel strips used for this purpose and which increases the heating rate during heating of the starting blank.

In order to achieve the largest possible process window during heating, the heating rate should be increased significantly more in the thickest sheet portion of the starting blank than in the thinnest sheet portion. This can be ensured by different method variants which are briefly explained hereinafter.

In principle, however, even an equal percentage increase in the heating rates in the thickest and thinnest blank parts leads to an alignment of the resulting necessary heating times. If e.g. the average heating rate in both regions is increased by 50% (in the thinnest region from 4 to 6 K/s and in the thickest region from 2 to 3 K/s), the difference in heating times of e.g. 20° C. to 800° C. between the thickest and thinnest blank parts is reduced from 195 seconds to 130 seconds). Therefore, a blank having different sheet thicknesses is already subjected to an alignment of the heating rates when the pre-coating is applied to the entire surface with a constant layer weight.

In accordance with the invention, the teaching of the invention therefore also includes a starting blank for producing a press-form-hardened steel component having an aluminum-based coat, in which the starting blank has different sheet thicknesses, which is characterised in that an inorganic iron-containing conversion layer is formed on the aluminum-based coat with a layer weight related to iron of 3-30 mg/m², advantageously 5-25 mg/m², particularly advantageously 7-20 mg/m².

In accordance with the invention, this starting blank can be produced from a flexibly rolled steel strip or also from sheet portions welded together (TWB, Tailor Welded Blanks). In the case of sheet portions which are welded together, provision is advantageously made that they have different strengths as required in order to take account of different stresses in the operating state. The differences in the strength of the materials should be more than 50 MPa for economic reasons. All hardenable steel grades, in particular manganese-boron steels, such as e.g. 22MnB5, can be considered as suitable steel grades for the starting blank.

In the case of blanks which have been joined together from two or more starting blanks having different sheet thicknesses (TWB), only the sheet portion having the greatest sheet thickness(es) can be provided with the inorganic iron-containing conversion layer as a pre-coating, either partially or over the entire surface, in order to bring the heating rates in the different parts of the blank closer together.

In an advantageous embodiment of the invention, it is also feasible, in the case of blanks having more than two sheet thicknesses, to apply the inorganic iron-containing conversion layer by tailoring the iron layer to suit the respective sheet thickness in such a way that the resulting blank heats up homogeneously. In the case of joined blanks consisting of a plurality of sheet thicknesses, the inorganic iron-containing conversion layer can already be applied as a pre-coating to the aluminum-based coat of the steel strip at the premises of the steel manufacturer. Ultimately, however, the pre-coating with the inorganic iron-containing conversion layer of individual blanks or blank regions also represents an implementation in accordance with the invention.

In the case of blanks which have a difference in sheet thickness as a result of a cold-rolling step, the inorganic iron-containing conversion layer can be applied as a pre-coating over the entire surface before or after the cold-rolling step or else only partially in the region having the greatest sheet thickness after the rolling procedure. The partial application after the rolling step only in the thicker blank region shows the best effectiveness, whereby the heating rates can be fully aligned. During the application before the rolling step, there is also a significant alignment of the heating rates, since the flexible rolling step greatly weakens the effectiveness of the pre-coating in the more thinly rolled blank part.

The pre-coating in accordance with the invention consists of applying iron compounds, preferably in a wet-chemical process. This consists at least of applying a solution of iron compounds which advantageously react with the Al-based metallic coat in an external current-free reaction. Preferably, this treatment is performed in the presence of compounds of other metals, e.g. from the group of cobalt, molybdenum and tungsten. For example, molybdates, tungstates or cobalt nitrate accelerate the deposition of the iron significantly but are themselves deposited only to a small extent, thus making the method in accordance with the invention even more efficient.

The removal of the naturally occurring oxide layer on the hot-dip coat based on aluminum and the deposition of the iron compounds can advantageously be performed simultaneously in a single wet-chemical step using alkaline media. Such deposition processes can be performed in continuously operating installations at strip speeds of up to 120 m/min or more. The required active substance quantity can be less than 100 mg/m².

### BRIEF DESCRIPTION OF THE DRAWINGS

FIG. 1 illustrates a layer structure of aluminum oxide on a steel substrate;

FIG. 2 graphical relationship of differences in diffusion layer thicknesses relative to difference in sheet thickness;

FIG. 3 illustration of test sample formed from hardenable 22MnB5;

FIG. 4 schematic summary of samples V1 to V4 treated with an iron-containing coating before or after the cold-rolling step; and

FIGS. 5a-5d illustrate the resulting heating curves of the variants V2 to V4 of FIG. 4, each in comparison with the reference measurements on variant V1.

### DETAILED DESCRIPTION OF THE PREFERRED EMBODIMENTS

During the tests it was found that from a layer weight of 3 mg/m² related to iron, advantageously 5 mg/m² related to iron, particularly advantageously 7 mg/m² related to iron, the heating rates can be significantly increased compared to an untreated reference. The maximum layer weight should not exceed 30 mg/m² related to iron. In addition, the increase in the heating rate is only small and the spot welding behaviour after press-hardening begins to deteriorate, which is why higher layer weights are not practical for economic and technological reasons. Advantageously, up to 25 mg/m² related to iron, particularly advantageously up to 20 mg/m² related to iron, are applied in order to keep the expenditure on active substances as low as possible.

The layer weights were determined using ICP-OES (optical emission spectroscopy with inductively coupled plasma). For this purpose, the conversion layer formed on the surface was chemically detached, then analysed and referenced against commercially available element standards.

The inventive treatment of the surface of the coated steel strip can be effected advantageously in a treatment part located downstream of the process part of a continuously producing hot-dip coating installation or a separate installation e.g. via spray bars with nozzles or in a dipping process. The separate installation can be e.g. a strip coating installation. Alkaline cleaning with subsequent rinsing upstream of the treatment in accordance with the invention advantageously removes the (native) oxide layer on the aluminum-based coat formed by atmospheric oxidation and thus creates a defined initial state for the deposition of the iron and/or compounds thereof in accordance with the invention.

The concentration of the deployment solution and the temperature thereof, the treatment time, the spray pressure, the shear of the sprayed-on solution relative to the surface of the metal strip to be treated, and the volume brought into contact with the surface can influence the amount of iron deposited on the surface.

The teaching of the invention further comprises a press-hardened component produced from a starting blank having an aluminum-based coat, having different sheet thicknesses with a thinnest and a thickest sheet portion, which is characterised in that a diffusion zone is formed between the steel substrate and the aluminum-based coat, consisting of metals of the coat and the steel substrate, wherein the diffusion zones in the different sheet thickness regions, in relation to the starting blank, have a maximum thickness difference which corresponds to the following relationship:

DIₘₐₓ≤8*((D1−D2)/D1),

where

D1: is the thickest sheet portion of the starting blank

D2: is the thinnest sheet portion of the starting blank

DIₘₐₓ: is the maximum thickness difference of the diffusion layer thicknesses on the hardened component.

In an advantageous embodiment of the invention, the maximum thickness difference DIₘₐₓ corresponds to the following relationship:

DIₘₐₓ≤6*((D1−D2)/D1)

In a particularly advantageous embodiment of the invention, the maximum thickness difference DIₘₐₓ corresponds to the following relationship:

DIₘₐₓ≤4*((D1−D2)/D1)

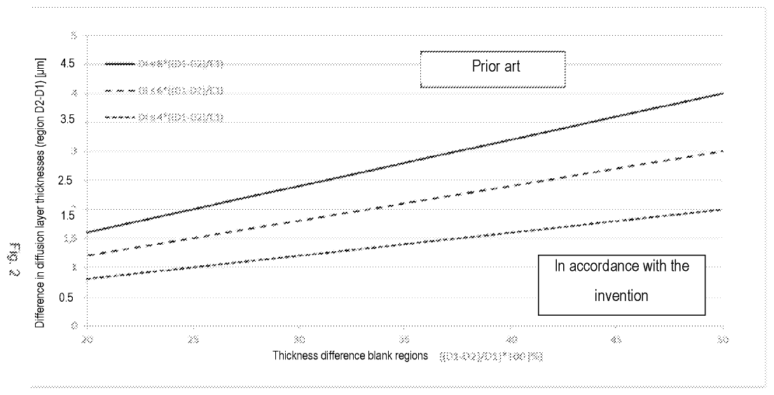

These relationships are graphically illustrated in FIG. 2. The three straight lines represent the aforementioned relationships DIₘₐₓ≤8*((D1−D2)/D1), DIₘₐₓ≤6*((D1−D2)/D1) and DIₘₐₓ≤4*((D1−D2)/D1). The region above the solid line which represents DIₘₐₓ≤8*((D1−D2)/D1) indicates the region which could hitherto be achieved by the prior art. The region below the solid straight line forms the region in accordance with the invention.

In accordance with the invention, the thickness of the diffusion zone between steel and the aluminum-based coat in the different sheet thickness regions should advantageously be between 2 and 14 μm, particularly advantageously between 4 and 12 μm, in order to ensure a sufficiently high but not excessive degree of alloying.

To explain these relationships, results from laboratory tests are described hereinafter.

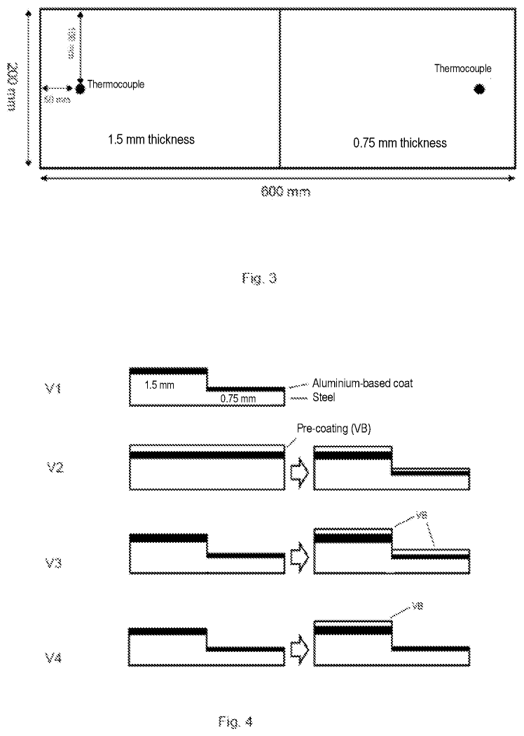

Sheet metal strips consisting of the hardenable steel 22MnB5 having a sheet thickness of 1.5 mm and an aluminum-silicon coat with a nominal layer weight of 150 g/m² on both sides were half-rolled by 50% in a laboratory cold-rolling stand and cut to a sample size of 200×600 mm², wherein the thickness transition lay in the middle (FIG. 3).

Thermocouples were applied at the edges of the samples and the heating rate was recorded in both sample regions in a furnace preheated to 920° C. Subsequently, the thickness of the diffusion layer was determined metallographically in a plurality of regions of the sample.

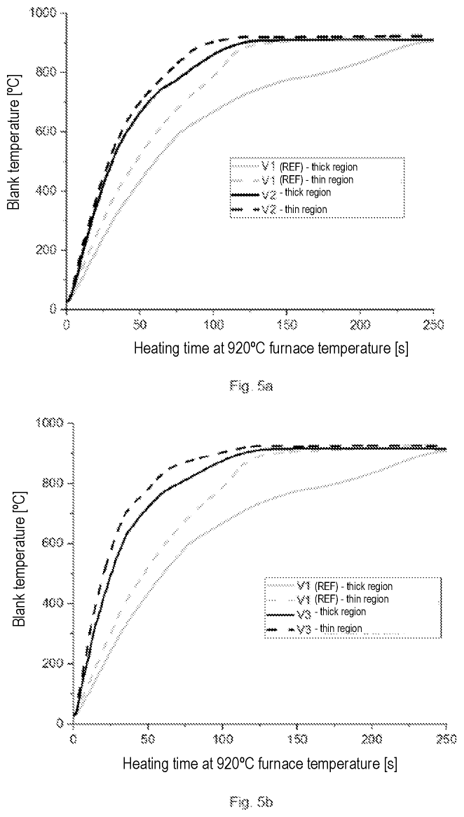

This procedure was likewise performed with samples which were treated with an iron-containing coating before or after the cold-rolling step. The tested variants V1 to V4 are as follows: V1—rolling (reference); V2—pre-coating, subsequent rolling; V3—rolling, subsequent pre-coating; V4—rolling, subsequent partial pre-coating. FIG. 4 shows a schematic summary of these different variants V1 to V4 (not to scale).

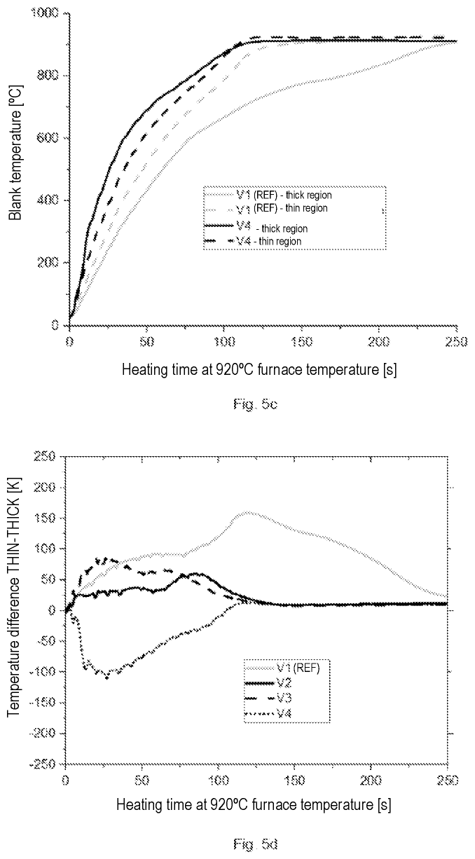

FIGS. 5a to 5d illustrate the resulting heating curves of the variants V2 to V4, each in comparison with the reference measurements on variant V1. In addition, the temperature difference between the thick and thin sample part is also illustrated as a function of the heating time. It can be clearly seen how, by means of the iron-containing pre-coating, the heating rates are aligned, in particular by reason of the very large increase in the heating rate in the thick sample part. This leads to a significant enlargement of the process window during heating in the course of the press-form hardening procedure.

Table 1 summarises the resulting diffusion layer thicknesses which were determined metallographically on several specimens from the respective sample regions (thick/thin) and averaged. The exploded view of this table 1 is provided for reasons of clarity. The diffusion layer thickness was determined on the basis of the current version of the VW works standard TL 4225.

TABLE 1

| | | | | Measured average diffusion | | |
|---|---|---|---|---|---|---|
| | | | | thicknesses and maximum | | |
| | | | | thickness difference | | |
| | | Sheet | | DImax [μm] | | |
| | | thickness | | | | DImax |
| | | [mm] | | Region | Region | (Region |
| Sample | Variant | D1 | D2 | D1 | D2 | D2 − D1) |
| V1_1 | V1-REF | 1.5 | 0.75 | 4 | 9 | 5 |
| V1_2 | V1-REF | 1.5 | 0.75 | 4 | 9 | 5 |
| V2_1 | V2-coating + | 1.5 | 0.75 | 7 | 9 | 2 |
| | rolling | | | | | |
| V2_2 | V2-coating + | 1.5 | 0.75 | 7 | 10 | 3 |
| | rolling | | | | | |
| V3_1 | V3-rolling + | 1.5 | 0.75 | 7 | 10 | 3 |
| | coating | | | | | |
| V3_2 | V3-rolling + | 1.5 | 0.75 | 8 | 11 | 3 |
| | coating | | | | | |
| V4_1 | V4-rolling + | 1.5 | 0.75 | 8 | 8 | 0 |
| | partial coating | | | | | |
| V4_2 | V4-rolling + | 1.5 | 0.75 | 7 | 9 | 2 |
| | partial coating | | | | | |

In accordance with the invention: DImax ≤

| | 8*((D1 − | 6*((D1 − | 4*((D1 − |
|---|---|---|---|
| Sample | D2)/D1) | D2)/D1) | D2)/D1) |
| V1_1 | NO | NO | NO |
| V1_2 | NO | NO | NO |
| V2_1 | YES | YES | YES |
| V2_2 | YES | YES | NO |
| V3_1 | YES | YES | NO |
| V3_2 | YES | YES | NO |
| V4_1 | YES | YES | YES |
| V4_2 | YES | YES | YES |

These results were combined with supplementary tests, in which the influence of the iron-containing coating on the heating rate and diffusion layer thickness in the case of different sheet thicknesses, heating times and heating temperatures was examined. An almost linear increase in the thickness of the diffusion layer with the heating time could also be observed here. As a result of these tests, the previously presented formulaic relationships between the maximum thickness difference of the diffusion layer thickness and the sheet thickness difference of the starting blank were empirically determined.

As described above, an approximation of the heating rates leads to a small difference in the diffusion layer thicknesses and results in homogeneous component properties with regard to lacquering capability and spot-welding capability. What is particularly advantageous is an alloy grade related to the entire component having a diffusion layer thickness between 2 and 14 μm, particularly advantageously between 4 and 12 μm.

During production of components by press-hardening, the iron-containing pre-coating on the blank is not retained. Rather, in the course of heating, e.g. in a roller hearth furnace, an aluminum-rich oxide layer which is doped with iron cations is formed as a result of the inventive pre-coating of the starting blank with the inorganic iron-containing conversion layer. The iron cations suppress the otherwise usual self-limitation of aluminum oxide layer growth and lead to the formation of substantially thicker aluminum oxide layers during the heat treatment, wherein aluminum oxide layer thicknesses of over 50 nm are achieved.

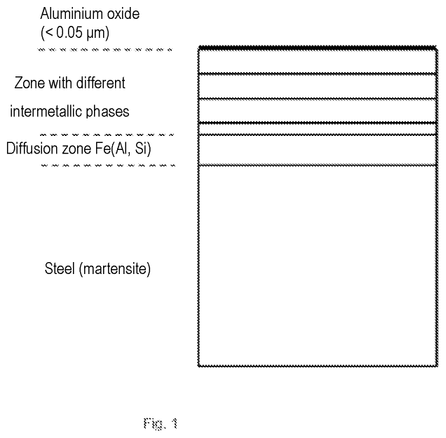

In contrast, typical aluminum oxide layer thicknesses on press-hardened components with an aluminum-based coat without an iron-containing pre-coating are significantly lower, as described with respect to FIG. 1. Thus, at least in the region having the high sheet thickness of the starting blank, components in accordance with the invention have a thickened aluminum oxide layer of more than 50 nm which results from the iron-containing pre-coating in combination with the heating before press-hardening.

An example of an advantageous method sequence is described hereinafter:
hot-rolling, acid-cleaning and optional cold-rolling of a suitable steel strip;
annealing the steel strip in a hot-dip coating installation in a reducing atmosphere at temperatures between 500 and 950° C. and subsequent hot-dipping in an aluminum-based melt and applying an aluminum-based coat on the steel strip with a layer weight between 60 and 200 g/m² on both sides;
subsequently applying an inorganic iron-containing conversion layer on the aluminum-based coat having a layer weight related to iron of 3-30 mg/m²;
flexibly rolling the steel strip having the aluminum-based coat so that the thin region of the resulting strip is 70% of the thickness of the thick region of the strip or less;
producing blanks from the flexibly rolled strip so that thick and thin sheet portions lie within each cut blank;
producing components by heating the blanks in a roller hearth furnace to temperatures between 750 and 1000° C. in order to adjust an austenitic microstructure at least in parts of the blank and subsequently forming in a tool to form a component with simultaneous rapid cooling so that a martensitic hardness microstructure is produced at least in parts of the component.

1. A method for producing a press-form-hardened component, comprising the steps of:
providing a steel strip having an aluminum-based coat;
applying an inorganic iron-containing conversion layer on the aluminum-based coat having a layer weight related to iron of 3-30 mg/m²;
cold-rolling the steel strip into a flexibly rolled strip having strip portions of different sheet thickness;
cutting a starting blank from the flexibly rolled strip, wherein the starting blank has different sheet thicknesses with a thinnest and a thickest sheet portion; and
press-form-hardening the starting blank to form a component.

2. A method for producing a press-form-hardened component, comprising the steps of:
providing a steel strip having an aluminum-based coat;
cold-rolling the steel strip into a flexibly rolled strip having strip portions of different sheet thickness;
cutting a starting blank from the flexibly rolled strip, wherein the starting blank has different sheet thicknesses with a thinnest and a thickest sheet portion;
before or after cutting the starting blank, applying an inorganic iron-containing conversion layer locally or to the entire surface of the aluminum-based coat having a layer weight related to iron of 3-30 mg/m² at least in the region of the thickest sheet portion; and
press-form-hardening the starting blank to form a component.

3. A method for producing a press-form-hardened component, comprising the steps of:
providing at least two steel strip portions having an aluminum-based coat which have different sheet thicknesses;
welding the steel strip portions together to form a starting blank, wherein the starting blank has different sheet thicknesses with a thinnest and a thickest sheet portion;
before or after welding said steel strip portions together, applying an inorganic iron-containing conversion layer locally or to the entire surface of the aluminum-based coat having a layer weight related to iron of 3-30 mg/m² at least in the region of the thickest sheet portion; and
press-form-hardening the starting blank to form a component.

4. The method as claimed in claim 1, wherein the inorganic iron-containing conversion layer on the aluminum-based coat has a layer weight related to iron of 5-25 mg/m².

5. The method as claimed in claim 1, wherein the inorganic iron-containing conversion layer on the aluminum-based coat is formed by applying a solution of iron compounds in an external current-free reaction with the aluminum-based metallic coat.

6. The method as claimed in claim 1, wherein the thinnest sheet portion of the starting blank has at most 80% of the thickness of the thickest sheet portion of the starting blank.

7. A starting blank for producing a press-form-hardened steel component having an aluminum-based coat, wherein the starting blank has different sheet thicknesses, and wherein an inorganic iron-containing conversion layer is formed on the aluminum-based coat with a layer weight related to iron of 3-30 mg/m², advantageously 5-25 mg/m², particularly advantageously 7-20 mg/m².

8. The starting blank as claimed in claim 7, wherein the starting blank is produced from a flexibly rolled strip consisting of steel.

9. The starting blank as claimed in claim 7, wherein the starting blank is produced from strip portions consisting of steel which are welded together.

10. The starting blank as claimed in claim 9, wherein the strip portions which are welded together in each case have different strengths with a difference in tensile strength of more than 50 MPa.

11. The starting blank as claimed in claim 7, wherein the starting blank comprises a hardenable manganese-boron steels.

12. The starting blank as claimed in claim 7, wherein the inorganic iron-containing conversion layer is applied on the aluminum-based coat with a layer weight related to iron of 3-30 mg/m² at least in the region of the thickest sheet portion on the starting blank.

13. A press-hardened component, produced from a starting blank comprising a steel substrate and having an aluminum-based coat and different sheet thicknesses, and having a thinnest and a thickest sheet portion, wherein a diffusion zone is formed between the steel substrate and the aluminum-based coat, consisting of metals of the coat and the steel substrate, wherein the diffusion zones in the different sheet thickness regions, in relation to the starting blank, have a maximum thickness difference which corresponds to the following relationship:
DIₘₐₓ≤8*((D1−D2)/D1),
where
D1: is the thickest sheet portion of the starting blank
D2: is the thinnest sheet portion of the starting blank
DIₘₐₓ: is the maximum thickness difference of the diffusion layer thicknesses on the hardened component.

14. The press-hardened component as claimed in claim 13, wherein the maximum thickness difference of the diffusion layer thicknesses on the hardened component is DIₘₐₓ≤6*((D1−D2)/D1).

15. The press-hardened component as claimed in claim 14, wherein the maximum thickness difference of the diffusion layer thicknesses on the hardened component is DIₘₐₓ≤4*((D1−D2)/D1).

16. The press-hardened component as claimed in claim 13, wherein the thickness of the diffusion zone between steel and the aluminum-based coat in the various sheet thickness regions is 2 to 14 μm or 4 to 12 μm.

17. The press-form hardened component as claimed in claim 13, wherein the component has an aluminum oxide layer of at least 50 nm thickness on the component surface in the region of the thickest sheet portion of the starting blank.
